(19) United States
(12) Patent Application Publication
(10) Pub. No.: US 2024/0169968 A1
(43) Pub. Date: May 23, 2024

(54) PRIVACY PROTECTION SYSTEMS AND METHODS

(71) Applicant: Frank Leo Serpico, Tallahassee, FL (US)

(72) Inventor: Frank Leo Serpico, Tallahassee, FL (US)

(21) Appl. No.: 17/991,395

(22) Filed: Nov. 21, 2022

(51) Int. Cl. G10K 11/175; H04R 1/02; H04R 1/24; H04R 3/12; H04R 31/00

(52) U.S. Cl. CPC G10K 11/1754; H04R 1/025; H04R 1/24; H04R 3/12; H04R 31/006

(57) ABSTRACT

Disclosed are systems and methods for privacy protection. In one embodiment, disclosed is a privacy protection apparatus having a bottom enclosure that houses a listening device. The apparatus includes a speaker and a source of vocal white noise placed in the bottom enclosure. The apparatus can also include a lid coupled to the bottom enclosure, and the lid houses a speaker and a source of vocal white noise. In some embodiments, the bottom enclosure includes a false bottom, and the lid includes a false top. The bottom enclosure can have an access port to, for example, receive a cable for charging the listening device.

### CROSS-REFERENCE TO RELATED APPLICATIONS

The present application claims priority to U.S. Provisional Patent Application No. 63/149,828 filed Feb. 16, 2020, entitled “PRIVACY PROTECTION SYSTEMS AND METHODS which is hereby incorporated by reference in its entirety.

### TECHNICAL FIELD

Embodiments relate generally to systems and methods for privacy protection against listening devices. In particular, embodiments are directed to systems and methods that use an enclosure and acoustics to prevent an electronic device from receiving an intelligible signal from speech produced outside of the enclosure.

### BACKGROUND

Often electronic devices are constantly linked to the Internet through, for example, a wireless network such as a mobile network or a Wi-Fi connection. A constant internet connection leaves electronic devices vulnerable unauthorized access. For example, smartphones are often targeted for eavesdropping on confidential conversations. Often a hacked smartphone will go unnoticed, and unauthorized parties may gain confidential information.

Smartphones, tablets, and the like include microphones that have active listening capabilities. The active listening capabilities typically cause the electronic device to monitor particular words that activate additional functions of the device and readies to receive a voice input. Some of these active listening capabilities can cause microphones to constantly pick up audio signals from their surroundings, regardless of whether the electronic device is currently in use. The active listening recognizes particular words and phrases, and uses that information to determine the content to display on the device. Often it would be preferable that private conversations are not monitored and/or stored. Therefore, it is desirable to provide a privacy protection system that masks oral speech and prevents the electronic device's microphone from actively monitoring private conversations or any other verbal communications.

Some known art devices provide electronic device storage boxes that prevent magnetic fields from effecting a mobile device by blocking wireless signals. This is undesirable for most individuals, as it leaves their mobile device unable to receive potentially important incoming transmissions. Further, some of electronic device storage boxes in the relevant field require the stored electronic device to be completely deactivated, thereby also preventing the user from receiving any type of incoming communication on the electronic device. Some storage containers generate noise to block stored electronic devices from recording. Known devices fail to provide a mechanism for charging the batteries of the stored electronic devices.

Known privacy protection systems isolate the device from the room. This isolation blocks everything from the device. These systems are expensive and prevent continued connectivity for communications. Additionally, such systems are often not sound proof, thereby, making conversations susceptible to privacy intrusions. Furthermore, these systems use white noise rather than vocal white noise, and hence, it is easier to breach privacy by filtering out voices from a recording.

### SUMMARY OF THE INVENTION

Embodiments are generally directed to privacy protection systems and methods. In one embodiment, a privacy protection apparatus includes a bottom enclosure configured for (a) housing a listening device, (b) at least one bottom speaker, and (c) a source of vocal white noise. The apparatus can also include a bottom speaker and a source of vocal white noise placed in the bottom enclosure. In one embodiment, the apparatus further includes a lid coupled to the bottom enclosure, and the lid is configured to house at least one lid speaker and a source of vocal white noise. The apparatus can also have lid speaker and a source of vocal white noise placed in the lid.

In one embodiment, the bottom enclosure is further configured to house a power converter and to have an access port. In some embodiments, the access port is configured to allow a cable to pass through into the bottom enclosure for data transmission and/or charging the listening device. In one embodiment, the bottom enclosure and the lid are made of a material that allows the listening device to continue to receive communication signals while housed within the privacy protection apparatus.

In one embodiment, the bottom enclosure is further configured to house a second source of vocal white noise. In some embodiments, the first source of vocal white noise in the bottom enclosure produces a signal that is different from a signal produced by the second source of vocal white noise in the bottom enclosure.

In yet another embodiment, the lid is further configured to house a power converter. In one embodiment, the lid is further configured to house a second source of vocal white noise. The second source of vocal white noise in the lid produces a signal that is different from a signal produced by the first source of vocal white noise in the lid.

In some embodiments, the first bottom speaker and the first source of vocal white noise are housed in a false bottom of the bottom enclosure. In other embodiments, the lid speaker and the source of vocal white noise in the lid are housed in a false top of the lid.

In one embodiment, a method of manufacturing a privacy protection system is provided. The can include the steps of providing a bottom enclosure configured for housing (a) a listening device, (b) a bottom speaker, and (c) a bottom source of vocal white noise; placing a bottom speaker and a bottom source of vocal white noise in the bottom enclosure; coupling a lid to the bottom enclosure, the lid configured to house a lid speaker and a lid source of vocal white noise; placing the lid speaker and the lid source of vocal white noise placed in the lid.

In some embodiments, method further includes providing a bottom enclosure having an access port. The access port is preferably configured to allow a cable to pass through into the bottom enclosure for data transmission and/or charging the listening device.

In one embodiment, the bottom enclosure includes second bottom source of vocal white noise. And, in one embodiment, the first bottom source of vocal white noise produces a signal that is different from a signal produced by the second bottom source of vocal white noise.

In some embodiments, the method can further include providing a lid that houses a second lid source of vocal white noise. And, in one embodiment, the first lid source of vocal white noise produces a signal that is different from a signal produced by the second lid source of vocal white noise.

In one embodiment, the method can also include further providing a false bottom in the bottom enclosure and placing the first bottom speaker and the first bottom source of vocal white noise in the false bottom.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 is a perspective view of a privacy protection system in accordance with one embodiment of the invention.

FIG. 2 is a perspective view of the privacy protection system shown in FIG. 1.

FIG. 3 is a plan front view of a lid for the privacy protection system shown in FIG. 1.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to Obscure the disclosure with details that will be readily apparent to those of ordinary skill in the art having the benefit of the description herein.

In general, the embodiments described herein relate to systems and methods for protecting the privacy of speech from a device listening to or recording conversations in, for example, the home, office, or car. In one embodiment, the system allows the device to continue receiving phone calls, entails, texts, and other communications, for example, and optionally charging the device wirelessly or by cable.

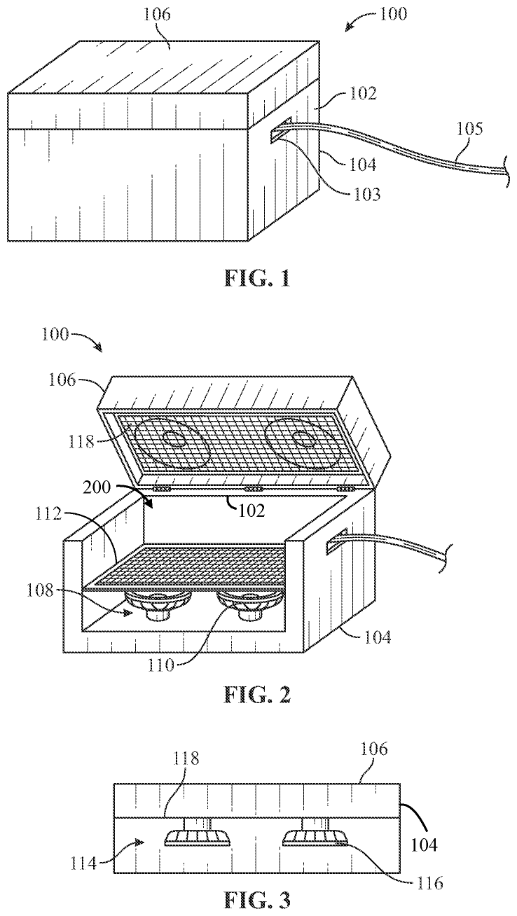

Referencing FIGS. 1-3, one embodiment of a privacy protection system 100 in accordance with the inventive systems and methods disclosed herein is shown. The privacy protection system 100 includes enclosure 102, which is composed in part of bottom enclosure 104 and lid 106. Bottom enclosure 104 is configured to receive and house an electronic device (not shown), which electronic device is to be prevented from breaching privacy of, for example, conversations taking place in a room where privacy protection system 100 is placed. In some embodiments, enclosure 102 includes access port 103 for allowing the passage of, for example, cable 105 for charging the device housed within enclosure 102. Access port 103 can be sealed, for example, with a rubber sealing mechanism.

In one embodiment, bottom enclosure 104 is configured with bottom speaker compartment 108 for receiving one or more bottom speakers 110. Bottom speaker compartment 108 can be configured additionally to store a power converter (not shown) and one or more audio sources (not shown). Bottom enclosure 104 can be provided with false bottom 112 to hide and/or enclose bottom speakers 110, the power converter, and the audio sources.

In one embodiment, lid 106 is configured with lid speaker compartment 114 for receiving lid speakers 116. Lid speaker compartment 114 can be configured additionally to store a power converter (not shown) and one or more audio sources (not shown). Lid 106 can be provided with false top 118 to hide and/or enclose lid speakers 116, the power converter, and the audio sources.

In one embodiment, bottom enclosure 104 is a box. In one embodiment, materials of different colors can be used for the box. In some embodiments, bottom enclosure 104 can be approximately 8-inches long, 4.5-inches wide, and 4.5-inches tall. False bottom 112 can sit about 1-inch above the actual bottom of bottom enclosure 104. In one embodiment, bottom enclosure 104 can be provided with rubber footings (not shown) placed along the outside of bottom enclosure 104 to prevent bottom enclosure 104 from moving or slipping off of surfaces.

In some embodiments, lid 106 is made of the same material as bottom enclosure 104. In one embodiment, lid 106 can be coupled to bottom enclosure 104 with hinges. Additionally, lid 106 and/or bottom enclosure 104 can be a lined with a spongey or malleable material to seal the lid 106 to the bottom enclosure 104.

During operation of system 100, in one embodiment, random vocal white noise is played inside enclosure 102 housing the listening device. The vocal white noise is produced by the source(s) of vocal white noise and played via speaker 108 and/or speaker 116. The random vocal white noise prevents the device from receiving an intelligible signal associated with speech produced outside enclosure 102. The random vocal white noise increases the difficulty of filtering out the voices from the noise. Using random vocal tones makes voices indiscernible from random noise. In one embodiment, a single source of random vocal white noise is used. In another embodiment, multiple sources of random vocal white noise are used. In some embodiments, each of the sources of vocal white noise produces a signal different from at least another of the sources of vocal white noise sources.

In specific reference to FIG. 2, the interior 200 of the enclosure 102 is illustrated. The bottom enclosure 104 is dimensioned to receive the electronic device (not shown) such that white noise is emitted and voices or other sounds outside of the enclosure 102 will not be audible to the microphone on the electronic device. In such, the interior 200 of the enclosure provides a secure storage space for the electronic device.

FIG. 3 illustrates the lid 106 forming a sealed connection to the bottom enclosure 104. In some embodiments, the lid 106 forms an airtight seal, or nearly airtight seal, to prevent audible signals from entering the interior of the enclosure. The seal formed by the lid 106 and bottom enclosure 104 in addition to the speakers 116 within the interior of the enclosure, provide a secure privacy protection system.

As used herein, the term “secure” is used to define an environment wherein the electronic device is positioned (at least temporarily) to reduce or eliminate the ability of the electronic device to receive audible signals from the exterior of the enclosure.

As used herein, the term “white noise” is used to describe an audible tone or tones used to prevent the device from receiving an intelligible signal associated with speech produced outside the enclosure 102. The white noise may be produced by a random signal having equal intensities at different frequencies or may be any audible tone which renders speech produced outside the enclosure inaudible.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A privacy protection apparatus comprising:
a bottom enclosure configured for housing a listening device, at least a first speaker, and a first source of vocal white noise;
at least a first speaker placed in said bottom enclosure;
at least a first source of vocal white noise placed in said bottom enclosure;
a lid coupled to said bottom enclosure, the lid configured to house at least a second speaker and a second source of vocal white noise; and
at least a second speaker placed in said lid;
at least a second source of vocal white noise placed in said lid.

2. The privacy protection apparatus of claim 1, wherein the bottom enclosure is further configured to house a power converter.

3. The privacy protection apparatus of claim 1, wherein the bottom enclosure is further configured with an access port.

4. The privacy protection apparatus of claim 3, wherein the access port is configured to allow a cable to pass through into the bottom enclosure for data transmission and/or charging the listening device.

5. The privacy protection apparatus of claim 1, wherein the bottom enclosure is further configured to house a third source of vocal white noise.

6. The privacy protection apparatus of claim 5, wherein the first source of vocal white noise produces a signal that is different from a signal produced by a third source of vocal white noise.

7. The privacy protection apparatus of claim 1, wherein the lid is further configured to house a power converter.

8. The privacy protection apparatus of claim 1, wherein the lid is further configured to house a fourth source of vocal white noise.

9. The privacy protection apparatus of claim 8, wherein the second source of a vocal white noise produces a signal that is different from a signal produced by the fourth source of vocal white noise.

10. The privacy protection apparatus of claim 1, wherein the first speaker and the first source of vocal white noise are housed in a false bottom of the bottom enclosure.

11. The privacy protection apparatus of claim 1, wherein the second speaker and the second source of vocal white noise are housed in a false top of the lid.

12. The privacy protection apparatus of claim 1, wherein the bottom enclosure and the lid are made of a material that allows the listening device to continue to receive communication signals while housed within the privacy protection apparatus.

13. A method of manufacturing a privacy protection system, the method comprising:
providing a bottom enclosure configured for housing a listening device, at least a first speaker, and a first source of vocal white noise;
placing at least a first speaker placed in said bottom enclosure;
placing at least a first source of vocal white noise in said bottom enclosure;
coupling a lid to said bottom enclosure, the lid configured to house at least a second speaker and a second source of vocal white noise;
placing a second speaker placed in said lid; and
placing a second source of vocal white noise placed in said lid.

14. The method of claim 13, wherein providing a bottom enclosure comprises providing a bottom enclosure further configured with an access port.

15. The method of claim 14, wherein the access port is configured to allow a cable to pass through into the bottom enclosure for data transmission and/or charging the listening device.

16. The method of claim 1, wherein providing the bottom enclosure comprises providing a bottom enclosure that is further configured to house a third source of vocal white noise.

17. The method of claim 16, wherein the first source of vocal white noise produces a signal that is different from a signal produced by the third source of vocal white noise.

18. The method of claim 13, wherein coupling a lid comprises providing a lid that is further configured to house a fourth source of vocal white noise.

19. The method of claim 18, wherein the second source of vocal white noise produces a signal that is different from a signal produced by the fourth source of vocal white noise.

20. The method of claim 13, further comprising providing a false bottom in the bottom enclosure, and further comprising placing the first speaker and the first source of vocal white noise in the false bottom.
